(19) United States
(12) Patent Application Publication
(10) Pub. No.: US 2013/0195180 A1
(43) Pub. Date: Aug. 1, 2013

(54) ENCODING AN IMAGE USING EMBEDDED ZERO BLOCK CODING ALONG WITH A DISCRETE COSINE TRANSFORMATION

(71) Applicant: Shih-Ta Hsiang, New Taipei City (TW)

(72) Inventor: Shih-Ta Hsiang, New Taipei City (TW)

(73) Assignee: MOTOROLA MOBILITY, INC., Libertyville, IL (US)

(21) Appl. No.: 13/363,852

(22) Filed: Feb. 1, 2012

(51) Int. Cl. H04N 7/50

(52) U.S. Cl. 375/240.12; 375/E07.211

(57) ABSTRACT

An image (a still image or a frame of a video) is divided into macroblocks. The content of a macroblock is predicted based on the content of other macroblocks that are spatially or temporally close to the instant macroblock. The prediction is compared against the actual macroblock content to yield a residual value. The residual is then transformed by a discrete cosine (“DCT”) transformation. The resulting DCT coefficients are grouped into subbands. The subbands are encoded using embedded zero block bitplane coding (“EZBC”), and the EZBC output is sent to a decoder (usually on a device remote from the encoder). The EZBC output is also decoded by a subband-dequantizer process whose output coefficients are fed into an inverse DCT to reconstruct the residual signal. The reconstructed residual is used to refine the coding process.

### FIELD OF THE INVENTION

The present invention is related generally to digital imaging and, more particularly, to compressing digital images.

### BACKGROUND OF THE INVENTION

As the availability of high definition (“HD”) video continues to increase, it will dominate the video market in the upcoming decades. Such an extensive use of HD video requires a significant amount of bandwidth for storage and transmission. For example, an HD spatial resolution of 1920×1080 progressive scan (“1080p”) results in approximately three Gigabits of uncompressed data per second of content. This enormous data rate gives rise to unprecedented visual quality which is well suited for liquid-crystal displays and plasma displays. On the other hand, high data rates place a burden on the transmission and storage of high definition video. For a typical example, a standard DVD-5 can only hold about twelve seconds of such content. This example highlights the need for exceptional compression systems for dealing with HD video. The current state-of-the-art video coding standard H.264/JVT/AVC/MPEG-4 provides substantial compression efficiency compared to earlier video coding standards. However, it is still desirable to exceed what is provided by this standard.

### BRIEF SUMMARY

The above considerations, and others, are addressed by the present invention, which can be understood by referring to the specification, drawings, and claims. The present invention divides an image (a still image or a frame of a video) into macroblocks. The content of a macroblock is predicted based on the content of other macroblocks that are spatially or temporally close to the instant macroblock. The prediction is compared against the actual macroblock content to yield a residual value. The residual is then transformed by a discrete cosine (“DCT”) transformation. The resulting DCT coefficients are grouped into subbands. The subbands are encoded using embedded zero block bitplane coding (“EZBC”), and the EZBC output is sent to a decoder (usually on a device remote from the encoder).

The EZBC output is also decoded by a subband-dequantizer process whose output coefficients are fed into an inverse DCT to reconstruct the residual signal. The reconstructed residual is used to refine the coding process.

A image decoder uses the above reverse technique to convert the received EZBC output into a reconstituted macroblock. The macroblocks are formed again into an image.

Laboratory experiments show that an image codec made according to aspects of the present invention is scalable for coding bitrate, visual quality, and image resolution. The present codec is more robust in the face of transmission errors than other codecs and is comparable in performance to a state-of-the-art entropy codec.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram illustrating spatial and temporal sampling of images;

FIG. 2 is a schematic of a representative prior-art image encoder;

FIG. 3 is a schematic of a representative prior-art image decoder;

FIG. 4 is a block diagram illustrating a number of 4×4 intra prediction modes;

FIG. 5 is a block diagram illustrating a number of 16×16 intra prediction modes;

FIG. 6 is a block diagram illustrating motion-compensated prediction;

FIG. 7 is a block diagram illustrating a number of inter prediction partitioning modes;

FIG. 8 is a schematic of an image encoder according to one embodiment of the present invention;

FIG. 9 is a schematic of an image decoder according to one embodiment of the present invention;

FIGS. 10a and 10b together form a flowchart of a method for compressing and decompressing a digital image, according to aspects of the present invention;

FIG. 11 is a data-flow diagram illustrating how DCT coefficients are coded into a quadtree and how the quadtree is split when decoding;

FIG. 12 is a chart comparing PSNR gain of an embodiment of the present invention with a previous coding technique; and

FIG. 13 is a chart comparing PSNR gain at various bit-rates of an embodiment of the present invention with a previous coding technique.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

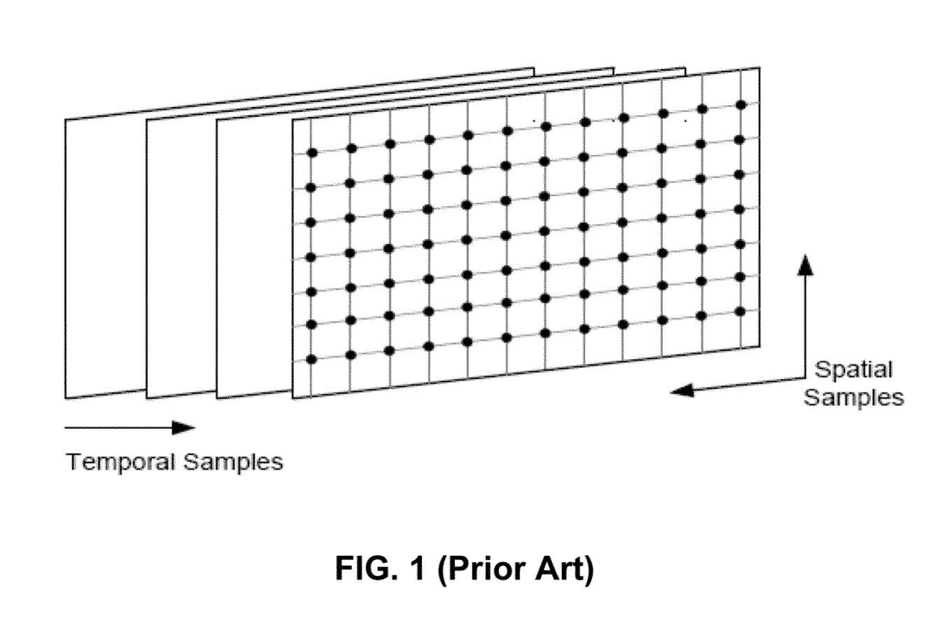

The present discussion begins with a very brief overview of some terms and techniques known in the art of digital image compression. This overview, accompanied by FIGS. 1 through 7, is not meant to teach the known art in any detail. Those skilled in the art know how to find greater details in textbooks and in the relevant standards.

A real-life visual scene is composed of multiple objects laid out in a three-dimensional space that varies temporally. Object characteristics such as color, texture, illumination, and position change in a continuous manner. Digital video is a spatially and temporally sampled representation of the real-life scene. It is acquired by capturing a two-dimensional projection of the scene onto a sensor at periodic time intervals. Spatial sampling occurs at points which coincide with a sampling grid that is superimposed upon the sensor output. Each point, called a pixel or a sample, represents the features of the corresponding sensor location by a set of values from a color space domain that describes the luminance and the color. A two-dimensional array of pixels at a given time index is called a frame. FIG. 1 illustrates spatio-temporal sampling of a visual scene.

Video encoding systems achieve compression by removing redundancy in the video data, i.e., by removing those elements that can be discarded without adversely affecting reproduction fidelity. Because video signals take place in time and space, most video encoding systems exploit both temporal and spatial redundancy present in these signals. Typically, there is high temporal correlation between successive frames. This is also true in the spatial domain for pixels which are close to each other. Thus, high compression gains are achieved by carefully exploiting these spatio-temporal correlations.

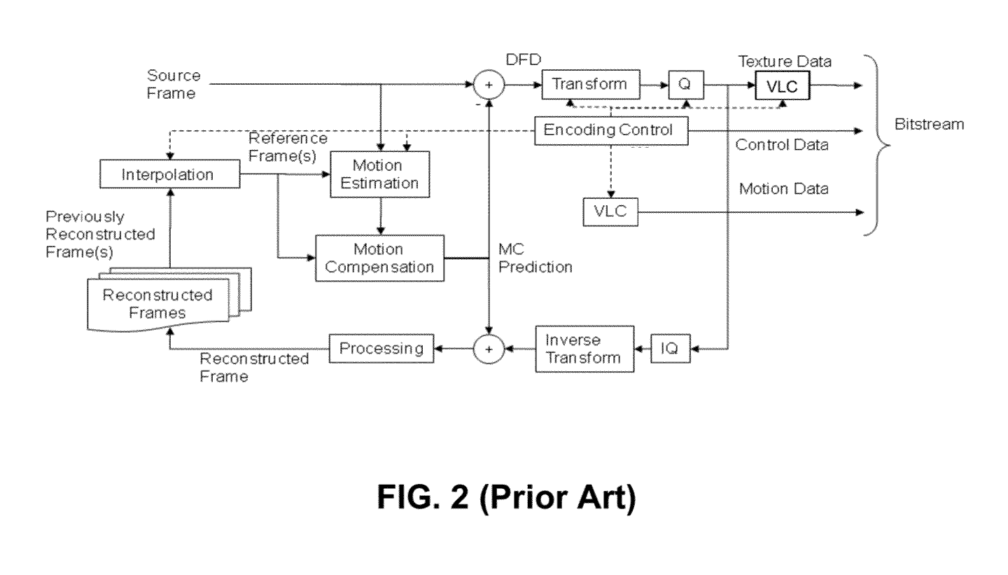

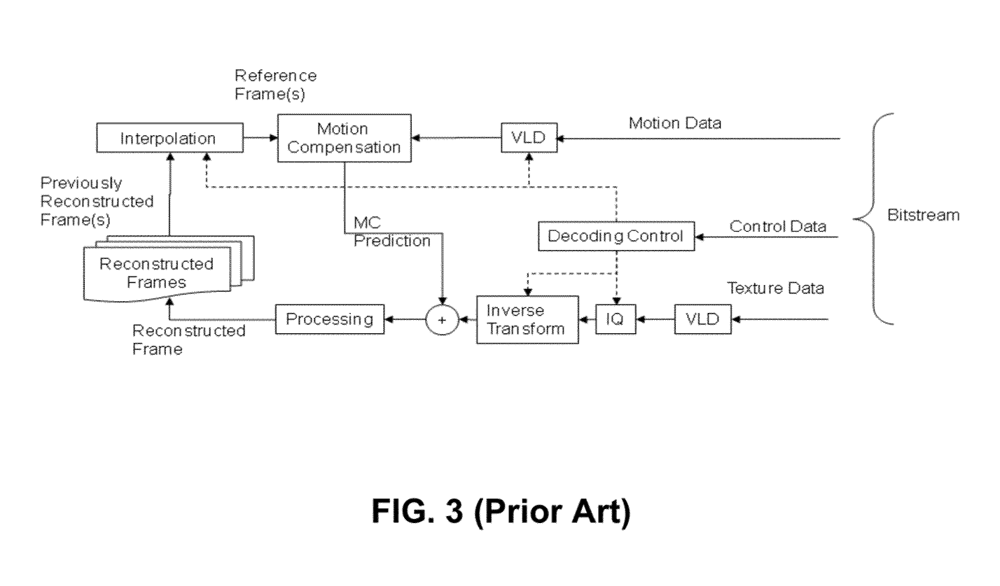

Consider one of the most widely adopted video coding schemes, namely block-based hybrid video coding. The major video coding standards, such as H.261, H.263, MPEG-2, MPEG-4 Visual, and the current state-of-the-art H.264/AVC are based on this model. A block-based coding approach divides a frame into elemental units called macroblocks. For source material in 4:2:0 YUV format, one macroblock encloses a 16×16 region of the original frame, which contains 256 luminance, 64 blue chrominance, and 64 red chrominance samples. Encoding a macroblock involves a hybrid of three techniques: prediction, transformation, and entropy coding. All luma and chroma samples of a macroblock are predicted spatially or temporally. The difference between the prediction and the original is put through transformation and quantization processes, whose output is encoded using entropy-coding methods. FIG. 2 shows an H.264/AVC video encoder built on a block-based hybrid video coding architecture. FIG. 3 shows a corresponding H.264/AVC video decoder.

Prediction exploits the spatial or temporal redundancy in a video sequence by modeling the correlation between sample blocks of various dimensions, such that only a small difference between the actual and the predicted signal needs to be encoded. A prediction for the current block is created from the samples which have already been encoded. In H.264/AVC, there are two types of prediction: intra and inter.

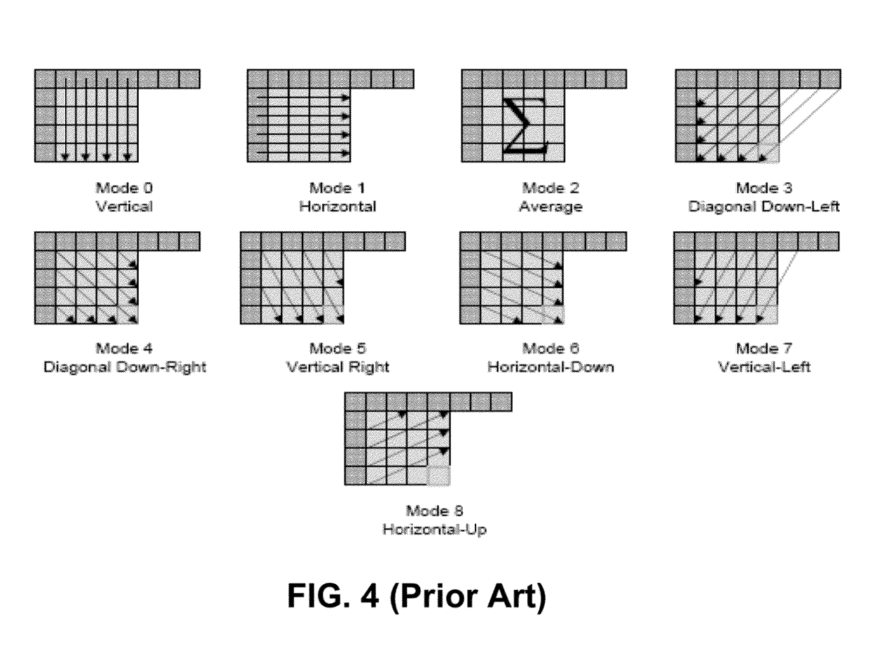

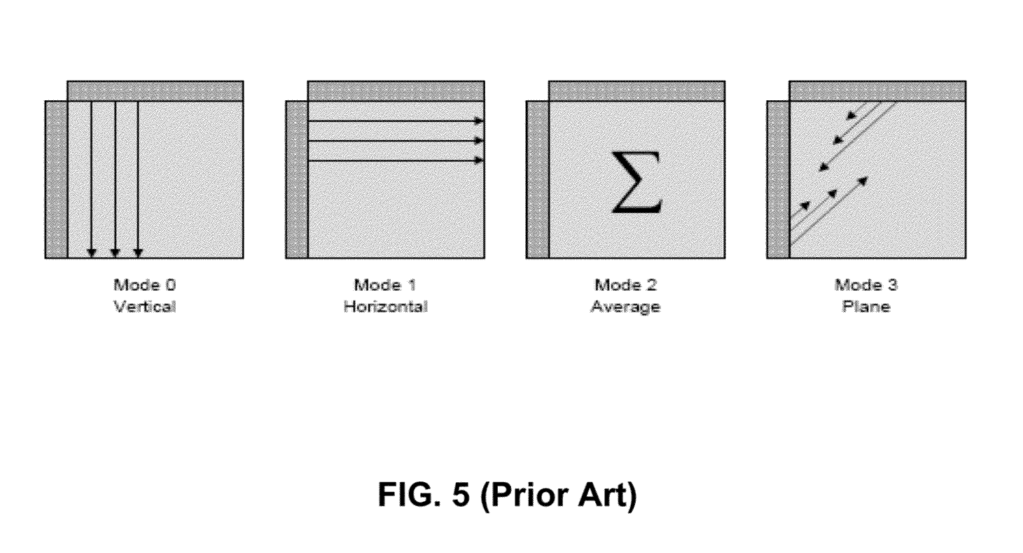

Intra Prediction: A high level of spatial correlation is present between neighboring blocks in a frame. Consequently, a block can be predicted from the nearby encoded and reconstructed blocks, giving rise to the intra prediction. In H.264/AVC, there are nine intra prediction modes for each 4×4 luma block of a macroblock and four 16×16 prediction modes for predicting the whole macroblock. FIGS. 4 and 5 illustrate the prediction directions for the 4×4 and the 16×16 intra prediction modes, respectively. The prediction can be formed by a weighted average of the previously encoded samples, located above and to the left of the current block. The encoder selects the mode that minimizes the difference between the original and the prediction and signals this selection in the control data. A macroblock that is encoded in this fashion is called an I-MB.

Inter Prediction: Video sequences have high temporal correlation between frames, enabling a block in the current frame to be accurately described by a region in the previous frames, which are known as reference frames. Inter prediction utilizes previously encoded and reconstructed reference frames to develop a prediction using a block-based motion estimation and compensation technique.

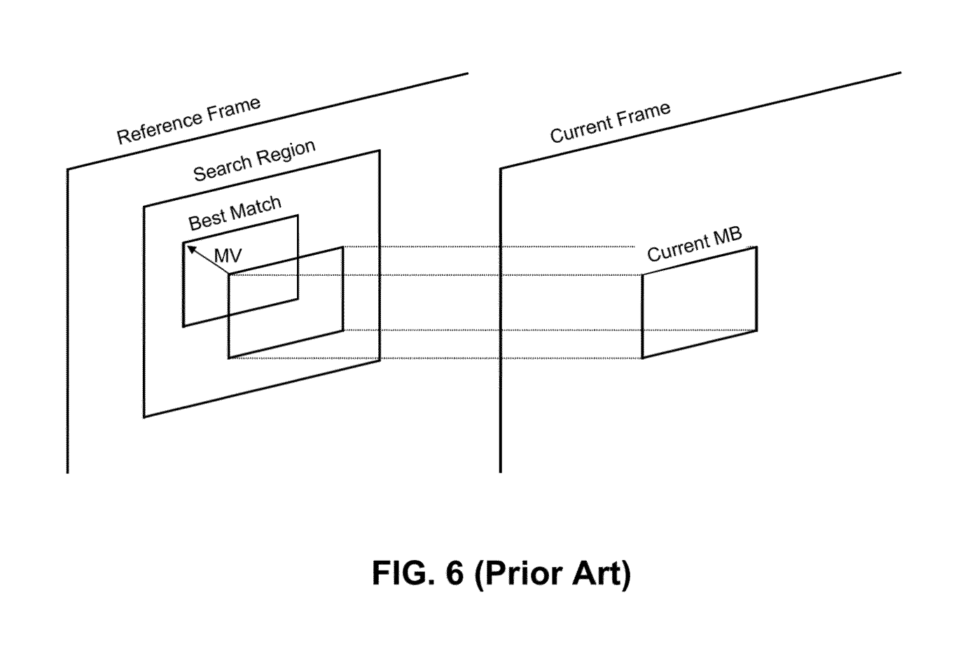

Most video coding systems employ a block-based scheme to estimate the motion displacement of an M×N rectangular block. In this scheme, the current M×N block is compared to candidate blocks in the search area of the reference frames. Each candidate block represents a prediction for the current block. A cost function is calculated to measure the similarity of the prediction to the actual block. Some popular cost functions for this method are sum of the absolute differences (“SAD”) and sum of the squared errors (“SSE”). The candidate with the lowest cost function is selected as the prediction for the current block. A residual is acquired by subtracting the current block from the prediction. The residual is subsequently transformed, quantized, and encoded. The displacement offset, or the motion vector, is also signalled in the encoded bitstream. The decoder receives the motion vector, determines the prediction region, and combines it with the decoded residual to reconstruct the encoded block. This process is called motion-compensated prediction and is illustrated in FIG. 6.

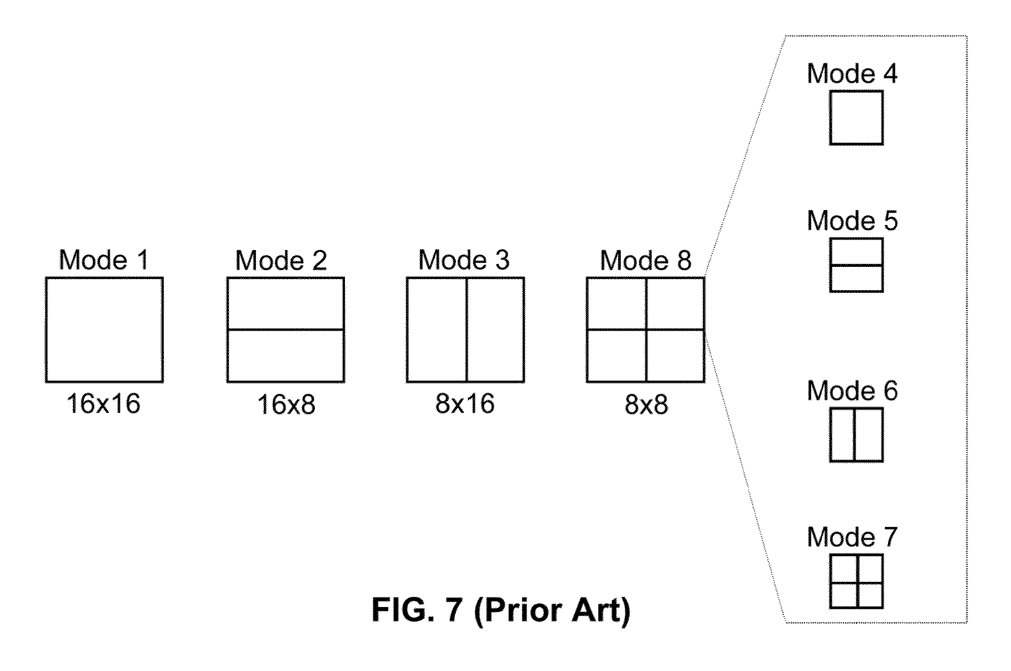

H.264/AVC uses more sophisticated methods for inter prediction. A 16×16 macroblock can be divided into partitions of size 16×16, 16×8, 8×16, or 8×8, where each block can be motion-compensated independently. If an 8×8 partitioning is selected, then the encoder can further choose to partition each 8×8 block into sub-partitions of size 8×8, 8×4, 4×8, or 4×4. Each partition is encoded independently with a motion vector and a residual of its own. The use of variable block sizes helps to obtain better motion prediction for highly textured macroblocks and increases coding efficiency by reducing the residual energy left to be encoded. FIG. 7 shows the partitioning modes used in H.264/AVC.

Another important factor affecting inter prediction accuracy is motion-vector precision. In H.264/AVC, precision of the motion vectors is one quarter of the distance between luma samples. If the motion vector happens to point to a non-integer position in the reference picture, then the value at that position is calculated using interpolation. Prediction samples at half-sample positions are obtained by filtering the original reference frame horizontally and vertically with a 6-tap filter. Sample values at quarter sample positions are derived bilinearly by averaging with upward rounding of the two nearest samples at integer and half-sample positions. Use of quarter-pel motion vector precision is one of the major improvements of H.264/AVC over its predecessors.

H.264/AVC also allows motion compensation using multiple reference frames. A prediction can be formed as a weighted sum of blocks from several frames. Furthermore, H.264/AVC supports use of future pictures as reference frames by decoupling display and coding order. This type of prediction is known as bi-predictive motion compensation. A macroblock that utilizes bi-predictive motion compensation is called a B-MB. On the other hand, if only the past frames are used for prediction, the macroblock is referred to as a P-MB.

The difference between the prediction and the original macroblock, the residual, is encoded for a high fidelity reproduction of the decoded sequence. H.264/AVC utilizes a block-based transformation and quantization technique to achieve this. A separable integer transform with similar properties to a DCT is applied to each 4×4 block of the residual. The transformation localizes and concentrates the sparse spatial information. This allows efficient representation of the information and enables frequency-selective quantization. Previous video coding standards used 8×8 DCT transforms, which were computationally expensive and prone to drift problems due to floating-point implementation. H.264/AVC relies heavily on intra and inter prediction, which makes it very sensitive to encoder-decoder mismatches and drift accumulation. In order to overcome these shortcomings, H.264/AVC uses a 4×4 integer transform and its inverse complement, which can be computed exactly in integer arithmetic using only additions and shifts. Also, the smaller transformation block size leads to higher compression efficiency and a reduction of reconstruction ringing artifacts.

In an H.264/AVC encoder, a 4×4 residual is transformed by a 4×4 integer transformation kernel. The entries of the result are scaled element-wise for DCT approximation and quantized for lossy compression.

Quantization reduces the range of values a signal can take, so that it is possible to represent the signal with fewer bits. In video encoding, quantization is the step that introduces loss, so that a balance between bitrate and reconstruction quality can be established. H.264/AVC employs a scalar quantizer whose step size is controlled by a quantization parameter.

H.264/AVC codecs combine transform scaling and quantization into a single step. A 4×4 input residual X is transformed into unscaled coefficients Y. Subsequently, each element of Y is scaled and quantized. Scaled and quantized coefficients of the 4×4 block are then reorganized into a 16×1 array in zig-zag order and sent to the entropy coder. At the decoder side, the process is reversed for rescaling and inverse transformation. A received coefficients block is pre-scaled with element-wise multiplication and inverse transformed to obtain the residual.

The entropy coder takes the syntax elements, such as the mode information and the quantized coefficients, and represents them efficiently in the bitstream. H.264/AVC employs two different encoders in order to achieve this: context-adaptive variable-length coding (“CAVLC”) and context-adaptive binary-arithmetic coding (“CABAC”).

Variable-length coding assigns short codewords to elements which appear with a high frequency in the system. H.264/AVC uses two different coding schemes in order to achieve coding efficiency and target decoder complexity. A simple exponential-Golomb table is employed for coding syntax elements. Exponential-Golomb codes can be extended infinitely in order to accommodate more codewords. On the other hand, quantized coefficients are encoded with the more efficient CAVLC. In this method, VLC tables are switched depending on the local statistics of the transmitted bitstream. Each VLC table is optimized to match different statistical bitstream characteristics. Using the VLC table that is better suited for the local bitstream increases the coding efficiency with respect to single-table VLC schemes.

Quantized transform coefficients, vector extracted using zig-zag scanning, yield large magnitude coefficients towards the beginning of the array, followed by sequences of ±1s, called trailing ones, and many zeros. CAVLC exploits these patterns by coding the number of nonzero coefficients, trailing ones, and coefficient magnitudes separately. Such a scheme allows for more compact and optimized design of VLC tables, contributing to the superior coding efficiency of H.264/AVC.

The quality of the reconstructed image sequence is determined to evaluate the performance of a video codec. Peak signal-to-noise ratio (“PSNR”) is an objective quality metric based on a logarithmic scale. It depends on the mean squared error between the original and the reconstructed frame. PSNR can be calculated easily and quickly, which makes it a very popular metric among video compression systems.

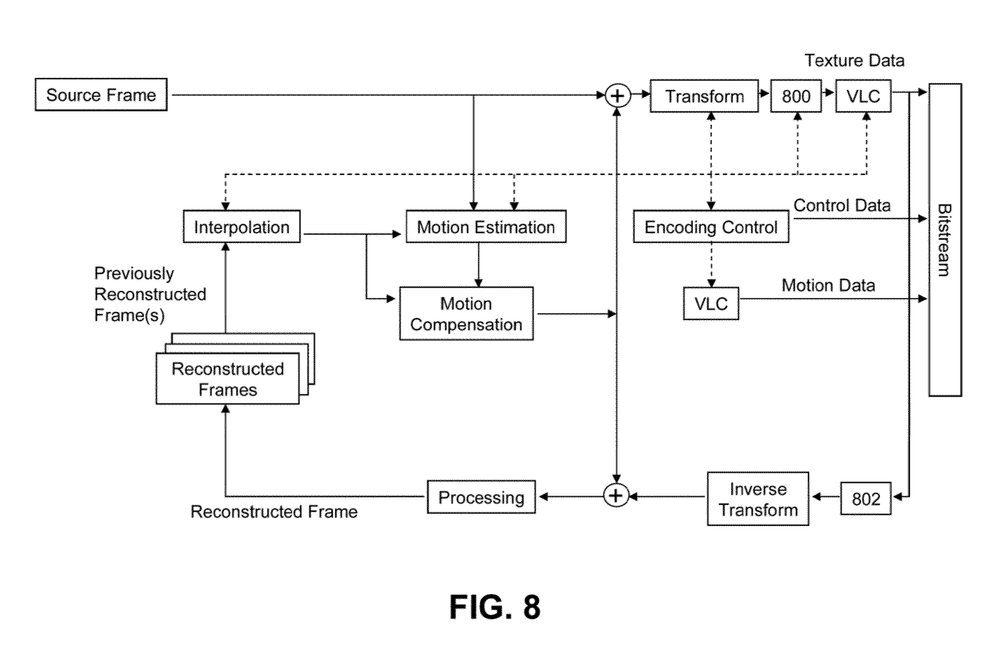

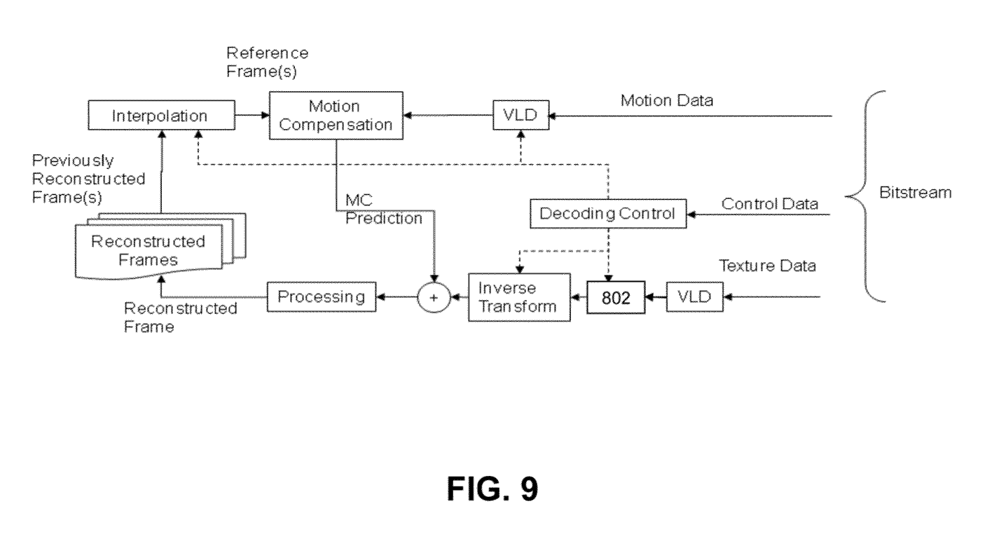

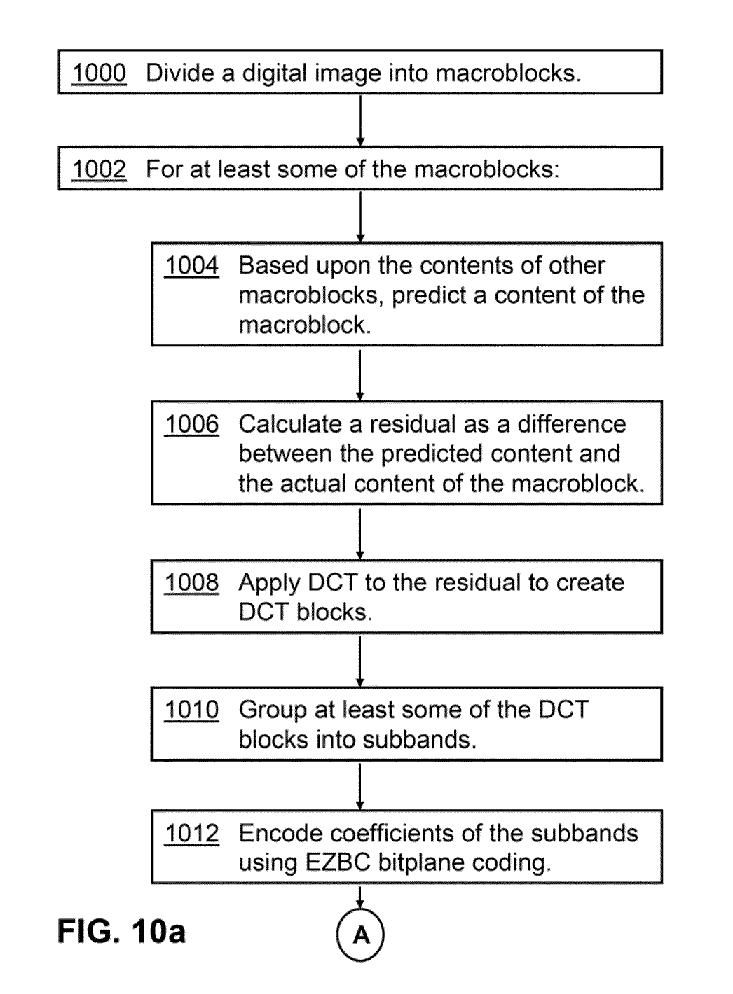

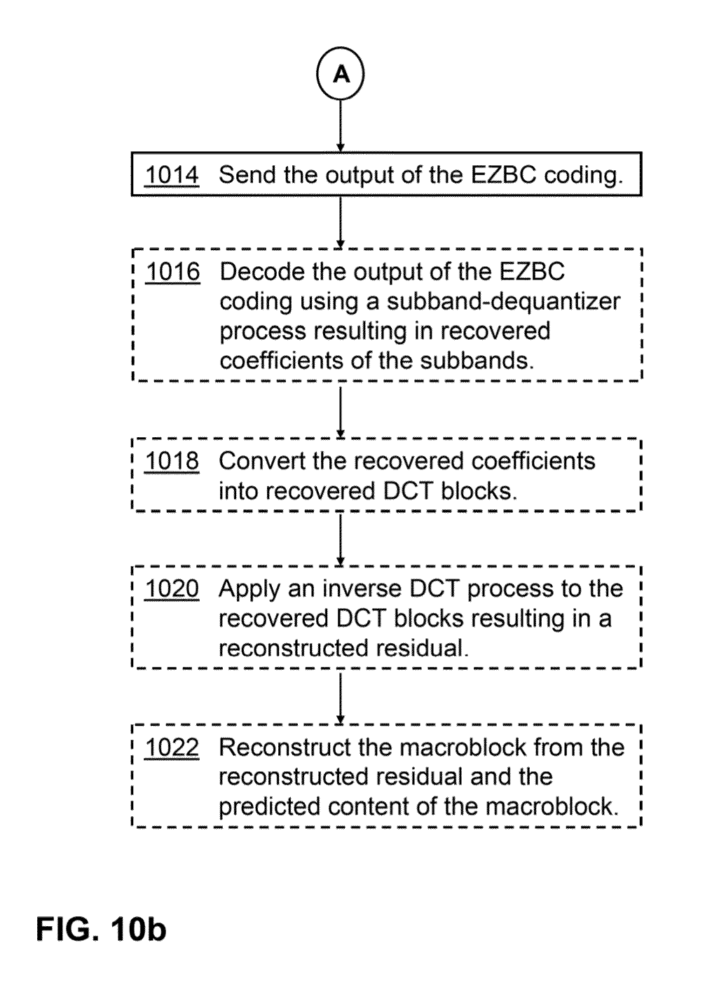

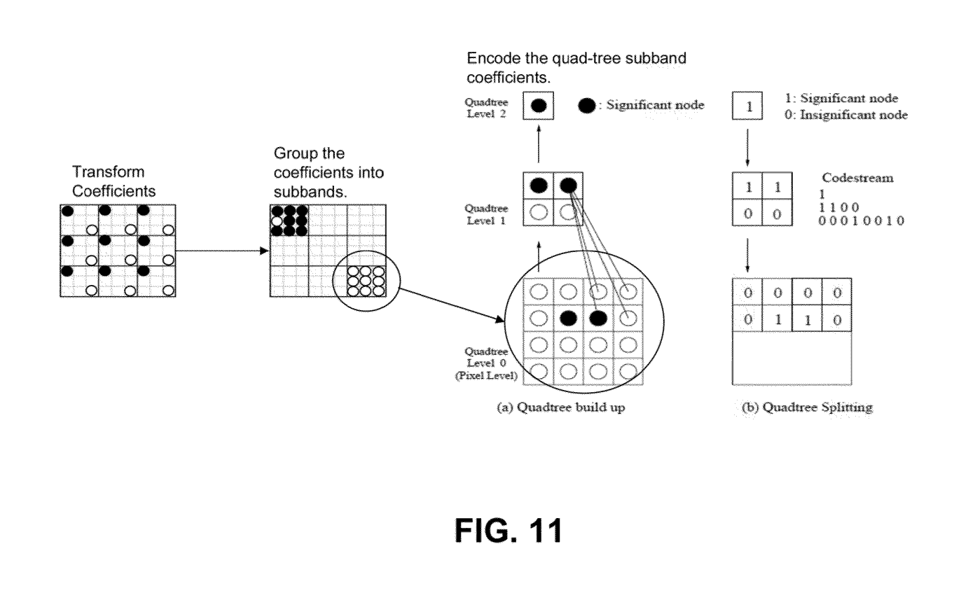

Now turning to the present invention, consider FIGS. 8 and 9. FIG. 8 shows the same encoder as in FIG. 2 but modified by functions 800 and 802. Function 800 (as explained in more detail below with reference to FIGS. 10 and 11) takes the DCT coefficients, groups them into subbands, and then encodes the subband coefficients using EZBC. The output of EZBC becomes part of the output bitstream.

Function 802 decodes the EZBC output, feeding into an inverse DCT. In FIG. 8 (the encoder), this decoded output is used to improve the coding, while in FIG. 9 (the decoder), function 802 is a step in reproducing the original frame from the encoded bitstream.

FIG. 10 presents a representative method for embodying aspects of the present invention. Because the encoder incorporates the decoder in this family of video codecs, the method of FIG. 10 describes both coding and decoding.

Encoding begins with step 1000 of FIG. 10a where the input image is divided into macroblocks, as is known in the art. As discussed above, each macroblock is usually either intra or inter.

For at least some macroblocks (step 1002), an intra/inter prediction procedure is executed to obtain the best prediction (step 1004). This step can be based on the conventional H.264 prediction procedures described above. The difference between an original macroblock and its prediction, the residual, is calculated in step 1006.

In step 1008, DCT is applied to the residual to create DCT blocks. The DCT coefficients are illustrated by the leftmost stage of the process of FIG. 11. The DCT coefficients are then grouped into resolution subbands in step 1010, as in known in the art (also shown in FIG. 11).

The subbands from step 1010 are then encoded in step 1012, using EZBC biplane coding. The DCT subband coefficients are analyzed using an quadtree algorithm (known in the art). See FIG. 11. Beginning at the level of individual pixels, each block of four nodes is reviewed to see if the significance of any node in the block is greater than a threshold value. If so, then the block as a whole is significant. Otherwise, the block is insignificant. This significance is maintained as the analysis progresses, where at each level a block of four nodes in the lower level is represented as one node in the higher level. When done, the top root node (shown as “Quadtree Level 2” in FIG. 11) corresponds to the maximum amplitude of all of the DCT subband coefficients in the corresponding block region. Data compression is achieved because large areas of insignificance are represented by one value. FIG. 11 shows both the build up of the quadtree using significance, and the inverse quadtree splitting, used in decoding.

The output of EZBC becomes part of the encoded output stream in step 1014 of FIG. 10b.

The remaining steps of FIG. 10b (1016 through 1022) serve to decode the EZBC-encoded output stream in a video decoder such as that illustrated in FIG. 9 and also serve as feedback input to the encoding process itself (as illustrated in FIG. 8).

In step 1016, subband-dequantization is applied to the EZBC-encoded stream to recover the subband coefficients. Specifically, the quadtrees are split as illustrated in FIG. 11.

The subband coefficients are then used to recover the DCT coefficients in step 1018.

As is well known in the art, an inverse DCT process can be applied to the DCT coefficients to recover the original residual for this macroblock (step 1020). The contents of this macroblock are predicted (by applying the intra/inter methods described above to other macroblocks that have already been decoded). Then the macroblock is reconstructed from the predicted content of the macroblock and the recovered residual (step 1022). The input image is recreated (though possibly with some coding loss) as the conjunction of the reconstructed macroblocks.

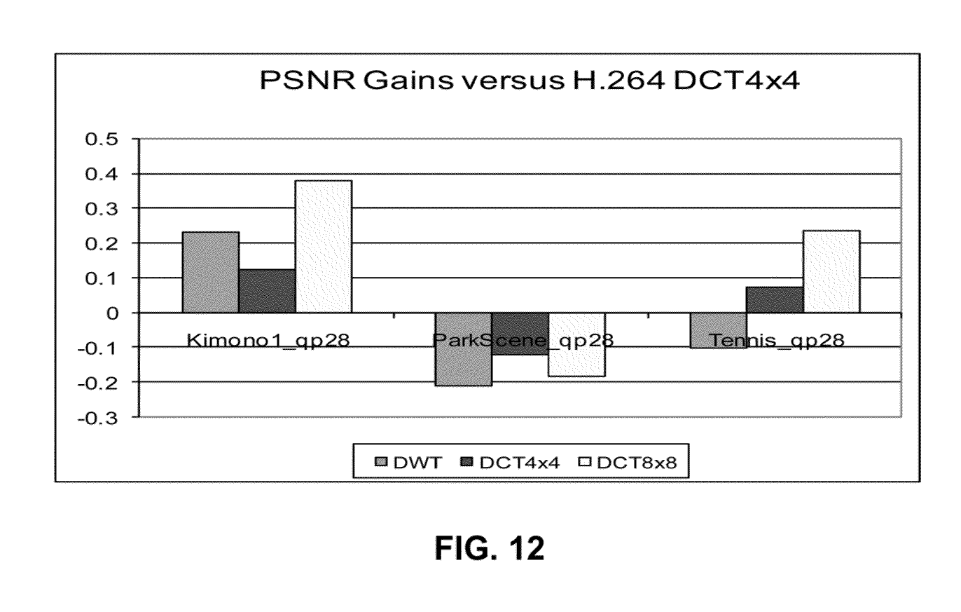

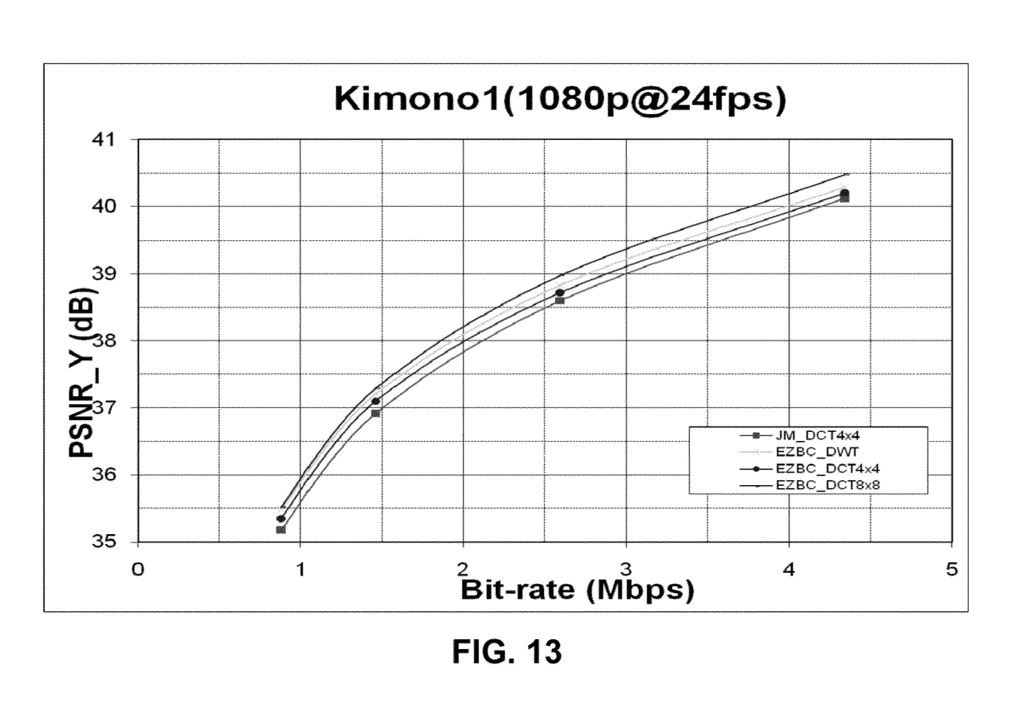

Laboratory experiments show that an image codec made according to aspects of the present invention is scalable for coding bitrate, visual quality, and image resolution. The present codec is more robust in the face of transmission errors than other codecs and is comparable in compression efficiency to a state-of-the-art entropy codec. FIGS. 12 and 13 show representative examples of the benefits of the present invention over conventional coding techniques.

In view of the many possible embodiments to which the principles of the present invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method for an image encoder to compress a digitally encoded image, the method comprising:
dividing, by the image encoder, the image into a plurality of macroblocks; and
for at least one macroblock of the plurality of macroblocks:
predicting, by the image encoder, a content of the macroblock, the predicting based, at least in part, on other macroblocks spatially near to the instant macroblock in the image or, if the image is a member of a temporal sequence of images, on macroblocks in another image previous to the instant image in the sequence;
calculating, by the image encoder, a residual as a difference between the predicted content of the macroblock and an actual content of the macroblock;
performing, by the image encoder, a discrete cosine transformation (“DCT”) on the residual to create DCT blocks;
grouping, by the image encoder, at least some of the DCT blocks into subbands;
encoding, by the image encoder, coefficients of the subbands using embedded zero block bitplane coding (“EZBC”); and
sending, by the image encoder, an output of the EZBC coding.

2. The method of claim 1 further comprising:
for at least one macroblock of the plurality of macroblocks:
decoding, by the image encoder, the output of the EZBC coding using a subband-dequantizer process resulting in recovered coefficients of the subbands;
converting, by the image encoder, the recovered coefficients into recovered DCT blocks;
performing, by the image encoder, an inverse DCT process on the recovered DCT blocks resulting in a reconstructed residual; and
reconstructing, by the image encoder, the macroblock from the reconstructed residual and the predicted content of the macroblock.

3. A method for an image decoder to decompress a digitally encoded image from a plurality of macroblocks, the method comprising:
for at least one macroblock of the plurality of macroblocks:
receiving, by the image decoder, EZBC-bitplane-coded subband coefficients;
decoding, by the image decoder, the EZBC-bitplane-coded subband coefficients using an inverse EZBC and dequantization process resulting in recovered coefficients of subbands;
converting, by the image decoder, the recovered coefficients into recovered DCT blocks;
performing, by the image decoder, an inverse DCT process on the recovered DCT blocks resulting in a reconstructed residual;
predicting, by the image decoder, a content of the macroblock, the predicting based, at least in part, on other macroblocks spatially near to the instant macroblock in the image or, if the image is a member of a temporal sequence of images, on macroblocks in another image previous to the instant image in the sequence; and
calculating, by the image decoder, a content of the macroblock, the calculating based, at least in part, on the reconstructed residual and on the predicted content of the macroblock; and
composing, by the image decoder, the digitally encoded image as a conglomeration of the plurality of macroblocks.

4. An image encoder for compressing a digitally encoded image, the image encoder comprising:
a communications interface configured for receiving the image; and
a processor configured for:
dividing the image into a plurality of macroblocks; and
for at least one macroblock of the plurality of macroblocks:
predicting a content of the macroblock, the predicting based, at least in part, on other macroblocks spatially near to the instant macroblock in the image or, if the image is a member of a temporal sequence of images, on macroblocks in another image previous to the instant image in the sequence;
calculating a residual as a difference between the predicted content of the macroblock and an actual content of the macroblock;
performing a discrete cosine transformation (“DCT”) on the residual to create DCT blocks;
grouping at least some of the DCT blocks into subbands;
encoding coefficients of the subbands using embedded zero block bitplane coding (“EZBC”); and
sending, via the communications interface, an output of the EZBC coding.

5. The image encoder of claim 4 wherein the processor is further configured for:
for at least one macroblock of the plurality of macroblocks:
decoding the output of the EZBC coding using a subband-dequantizer process resulting in recovered coefficients of the subbands;
converting the recovered coefficients into recovered DCT blocks;
performing an inverse DCT process on the recovered DCT blocks resulting in a reconstructed residual; and
reconstructing the macroblock from the reconstructed residual and the predicted content of the macroblock.

6. An image decoder for decompressing a digitally encoded image from a plurality of macroblocks, the image decoder comprising:
a communications interface; and
a processor configured for:
for at least one macroblock of the plurality of macroblocks:
receiving, via the communications interface, EZBC-bitplane-coded subband coefficients;
decoding the EZBC-bitplane-coded subband coefficients using an inverse EZBC and dequantization process resulting in recovered coefficients of subbands;
converting the recovered coefficients into recovered DCT blocks;
performing an inverse DCT process on the recovered DCT blocks resulting in a reconstructed residual;
predicting a content of the macroblock, the predicting based, at least in part, on other macroblocks spatially near to the instant macroblock in the image or, if the image is a member of a temporal sequence of images, on macroblocks in another image previous to the instant image in the sequence; and
calculating a content of the macroblock, the calculating based, at least in part, on the reconstructed residual and on the predicted content of the macroblock; and
composing the digitally encoded image as a conglomeration of the plurality of macroblocks.
